(19) United States
(12) Patent Application Publication
(10) Pub. No.: US 2006/0291748 A1
(43) Pub. Date: Dec. 28, 2006

(54) Method and apparatus to generate a pattern image

(75) Inventor: Sung-myun Lee, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/444,514

(22) Filed: Jun. 1, 2006

(30) Foreign Application Priority Data
Jun. 23, 2005 (KR) 2005-54549

(51) Int. Cl. G06K 9/32

(52) U.S. Cl. 382/298

(57) ABSTRACT

A method of generating a pattern image includes inputting a pattern ID and a scaling ratio of a first unit pattern, reading a pattern attribute stored corresponding to the pattern ID, calculating and storing a scaling pattern attribute indicating a second unit pattern obtained by scaling the first unit pattern according to the scaling ratio, and rendering a second pattern image including the second unit pattern to a corresponding area of a document according to the scaling pattern attribute.

### CROSS-REFERENCE TO RELATED APPLICATIONS

This application claims priority under 35 U.S.C. §119(a) of Korean Patent Application No. 2005-54549, filed Jun. 23, 2005 in the Korean Intellectual Property Office, the entire contents of which are incorporated herein by reference.

### BACKGROUND OF THE INVENTION

1. Field of the Invention

The present general inventive concept relates to a method and apparatus to generate a pattern image, and more particularly to a method and apparatus to generate a pattern image that prevents an image from being distorted when an enlargement or a reduction of a predefined printing pattern is performed.

2. Description of the Related Art

In general, once a print order to print a document-to-be-printed is written by an application program and is received by an image forming apparatus, a printer driver converts the document-to-be-printed into print data. The printer driver can be recognized by the image forming apparatus, according to various print order options, and transmits the print data to the image forming apparatus to be printed on paper.

Here, the print order options include an option for enlargement or reduction of the document to be printed. Once the print order option for enlargement or reduction is selected, the printer driver generates the print data that has an enlarged size or a reduced size according to an enlargement ratio or a reduction ratio included in the print order. Thus, the enlargement print order option and the reduction print order option are each scaling print orders.

When an image including a predefined pattern is included in the document-to-be-printed, the application program transmits a pattern ID corresponding to the predefined pattern to the printer driver. The printer driver generates a pattern image using a pre-saved bitmap pattern and enlarges or reduces (that is, scales) the generated pattern image, and then positions the scaled pattern image at a corresponding area of the print data.

FIG. 1 and FIG. 2 are views illustrating a conventional method for generating a pattern image.

Referring to FIG. 1, a bitmap pattern A illustrates a single example of a predefined pattern, and a bitmap pattern B illustrates a pattern image obtained by repeating the pattern A. That is, a typical pattern image is conventionally-generated by repeating a basic pattern. When an ordinary printing process is performed, in which a print order for enlargement or reduction is not provided, a pattern image obtained by the printing process is positioned in a designated area of a corresponding page of the print data.

Referring to FIG. 2, a bitmap pattern image C illustrates a pattern image constituted by the bitmap pattern A, and a bitmap pattern image D illustrates a pattern image generated by reducing the pattern image C. P In order to reduce the pattern image C constituted by the predefined pattern A, the printer driver receives a pattern ID corresponding to the predefined pattern A from an application program and generates the bitmap pattern image C as illustrated in FIG. 2. Then, the printer driver reduces the generated pattern image C according to a reduction ratio to generate the reduced bitmap pattern image D and positions the reduced bitmap pattern image D at a designated area of the corresponding page of the print data.

When generating the reduced bitmap pattern image D using the generated pattern image C, a rough calculation (such as a rounding down of a number to one decimal place) is required because of a characteristic of computer operation. Accordingly, a space between patterns of the reduced pattern image is irregular, as illustrated in the reduced bitmap pattern image D.

Referring to an enlarged section of the reduced bitmap pattern image D of FIG. 2 (i.e., the enlarged section between the two arrows in FIG. 2), it is possible to observe that a line disappeared as a result of the rough calculation in the computer operation. The disappearance of the line is referred to as a break phenomenon of the bitmap, which is generated frequently when one bitmap image is enlarged or reduced.

Accordingly, once the enlarged or reduced image is generated by using the predefined pattern in a conventional printing process, a damage of the generated image (that is, the break phenomenon of the bitmap) is generated. As a result, an image quality is not uniformed, and a printing quality is decreased.

### SUMMARY OF THE INVENTION

The present general inventive concept provides a method and apparatus to generate a pattern image, the method and apparatus being able to prevent the pattern image from being damaged when an enlarged or reduced image is generated using a predefined pattern.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of generating a pattern image, the method including inputting a scaling ratio and a pattern ID of a first unit pattern corresponding to a first pattern image of a document based on print data received in a scaling print order, reading a stored pattern attribute corresponding to the pattern ID, calculating and storing a scaling pattern attribute corresponding to a second unit pattern obtained by scaling the first unit pattern according to the scaling ratio, and rendering a second pattern image corresponding to the second unit pattern using the scaling pattern attribute.

The stored pattern attribute may include magnitude data of at least one portion of the first unit pattern.

The calculating and storing of the scaling pattern attribute may include scaling the magnitude data of the stored pattern attribute using the scaling ratio.

The calculating and storing of the scaling pattern attribute may include multiplying the magnitude data of the stored pattern attribute by a scaling coefficient to generate a resulting value, and calculating the scaling pattern attribute by converting the resulting value into an integral number.

The rendering of the second pattern image may include determining a predetermined area on a print medium to which the scaled pattern image is to be rendered from the print data, and rendering the second pattern image at a specific position on the print medium using the scaling pattern attribute, in which the specific position is located in the predetermined area.

The foregoing and/or other aspects and utilities of the present general inventive concept may also be achieved by providing an apparatus to generate a pattern image, the apparatus including a pattern attribute storage section to store a pattern attribute corresponding to a pattern ID of a predefined pattern, a pattern generating control section to control a generation of the pattern image by reading the pattern attribute corresponding the pattern ID from the pattern attribute storage section, calculating a scaling pattern attribute of a scaled pattern obtained by scaling the predefined pattern according to a scaling ratio, and storing the calculated the scaling pattern attribute in the pattern attribute storage section, and a pattern rendering section to render a scaled patterning image having the scaled pattern to a predefined area of a print medium according to the scaling pattern attribute.

The pattern attribute may include magnitude data of at least one portion of the predefined patter.

The pattern generating control section may scale the magnitude data using the scaling ratio to calculate the scaling pattern attribute.

The pattern generating control section may multiply the magnitude data by a scaling coefficient to generate a resulting value, and the pattern generating control section calculates the scaling pattern attribute by converting the resulting value into an integral number.

The pattern rendering section determining a predetermined area on a print medium to which the scaled pattern image is to be rendered from the print data, and the pattern rendering section renders the second the pattern image at a specific position on the print medium using the scaling pattern attribute, in which the specific position is located in the predetermined area.

The pattern image generating apparatus may be located in one of a printer driver and an image forming apparatus.

The foregoing and/or other aspects and utilities of the present general inventive concept may be achieved by providing a pattern image generating unit useable with a printing data output device, the pattern image generating unit including a pattern generation control unit to generate a scaled pattern attribute from an input pattern attribute, a pattern attribute storage unit to store the scaled pattern attribute generated by the pattern generation control unit, and a pattern rendering unit to render scaled pattern image data using the scaled pattern attribute.

The foregoing and/or other aspects and utilities of the present general inventive concept may also be achieved by providing a printing device to print a scaled pattern image, the scaled pattern image printing device including a pattern image generating unit to drive the generation of scaled pattern image data, the pattern image generating unit including a pattern generation control unit to generate a scaled pattern attribute from an input pattern attribute, a pattern attribute storage unit to store the scaled pattern attribute generated by the pattern generation control unit, and a pattern rendering unit to render the scaled pattern image data using the scaled pattern attribute, and a controller to control one or more operations of the printing device.

The printing device may further include a user input section to receive at least one print order, a printer driver comprising the pattern image generating unit, an application program unit to transmit a pattern ID of an input pattern and a scaling ratio to the printer driver, and an interface unit to transmit the scaled pattern image data to an image forming apparatus connected to the scaled pattern image printing device. The printing device may further include a printing engine unit to print a scaled pattern image using the scaled pattern image data, and an interface unit to transmit the scaled pattern image data to the printing engine unit, in which the scaled pattern image printing device is an image forming apparatus.

The foregoing and/or other aspects and utilities of the present general inventive concept may also be achieved by providing a system to generate a scaled pattern image, the system including an image forming apparatus to print the scaled pattern image, a printing data output device to output scaled pattern image data, and a pattern image generating unit to drive the generation of the scaled pattern image data, the pattern image generating unit including a pattern generation control unit to generate a scaled pattern attribute from an input pattern attribute, a pattern attribute storage unit to store the scaled pattern attribute generated by the pattern generation control unit, and a pattern rendering unit to render the scaled pattern image data using the scaled pattern attribute. The pattern image generating unit may be located in the image forming apparatus.

The foregoing and/or other aspects and utilities of the present general inventive concept may also be achieved by providing a method of generating a scaled pattern image, the method including generating scaled pattern attribute from an input image pattern attribute, storing the scaled pattern attribute, and rendering the scaled pattern image data by scaling the input image pattern attribute using the scaled pattern attribute. The generating the scaled pattern attribute may include determining a pattern ID corresponding to the input image, determining a pattern attribute corresponding to the pattern ID, calculating a scaling coefficient using a predetermined scaling ratio, generating the scaled pattern attribute using the scaling coefficient. The method may further include converting the scaled pattern attribute to an integral number.

The foregoing and/or other aspects and utilities of the present general inventive concept may also be achieved by providing an apparatus to generate a pattern image, including a storage unit to store first data corresponding to an image having one or more pattern images and second data corresponding to one or more attributes of the one or more pattern images of the image, and a control unit to scale the one or more pattern images of the image according to the first data, the second data, and third data corresponding to one or more second attributes of a second image to generate the second image having the scaled pattern images.

The apparatus may further include an image forming apparatus having a print engine to print the second image, in which the storage unit and the control unit are included in the image forming apparatus. The apparatus may further include a host having the storage unit and the control unit to generate the second image, and an image forming apparatus to print the second image. The number of the scaled pattern images may be greater than the number of the one or more pattern images. The one or more attributes of the one or more pattern images may include a length with respect to a line along which the one or more pattern images are arranged. A ratio between the one or more attributes and the one or more second attributes may include a reduction and/or enlargement ratio. The reduction and/or enlargement ratio may include a ratio between the first image and the second image. The reduction and/or enlargement ratio may include a ratio between the one or more pattern images and the one or more second pattern images. The one or more pattern images and the one or more second pattern images may have a common attribute that does not vary when the second image is printed from the first image.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 and FIG. 2 are views illustrating a conventional method of generating a pattern image;

FIG. 3 is a block diagram illustrating a device to output printing data using a pattern image generating apparatus according to an embodiment of the present general inventive concept;

FIG. 4 is a block diagram illustrating a pattern image generating section of FIG. 3;

FIG. 5 to FIG. 7 are views illustrating a method of generating a pattern image according to an embodiment of the present general inventive concept;

FIG. 8 is a flow chart illustrating a method of generating a pattern image according to an embodiment of the present general inventive concept; and

FIG. 9 is a block diagram illustrating an image forming apparatus having a pattern image generating apparatus according to an embodiment of the present general inventive concept.

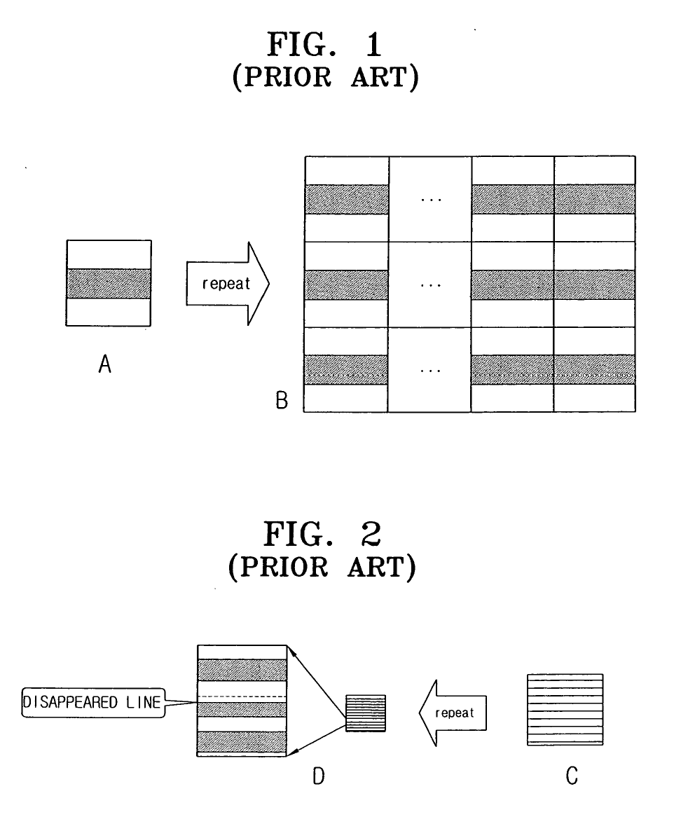

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

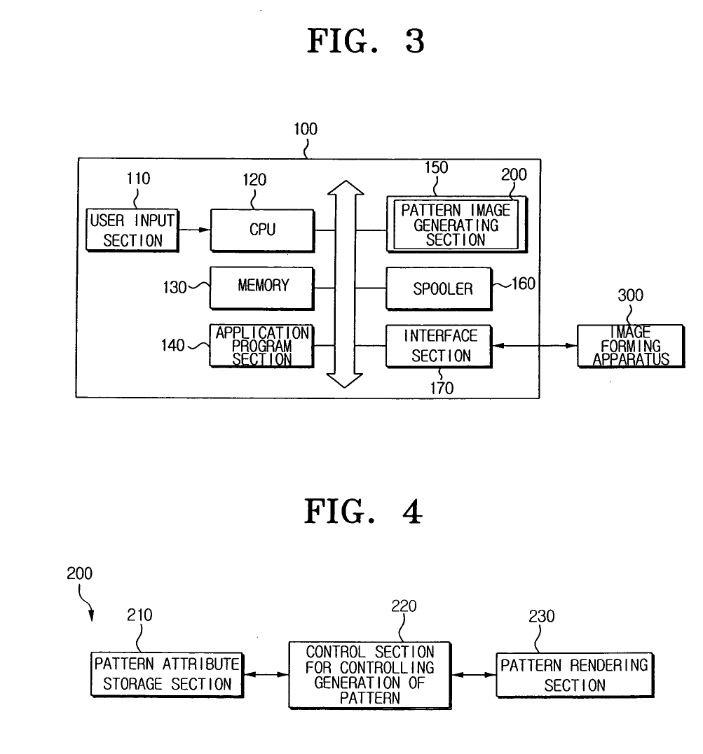

FIG. 3 is a block diagram illustrating a print data output device 100 to output printing data using a pattern image generating apparatus according to an embodiment of the present general inventive concept. FIG. 4 is a block diagram illustrating a pattern image generating section of FIG. 3.

Referring to FIG. 3, the print data output device 100, to which the pattern image generating apparatus according to an embodiment of the present general inventive concept is applied, generates the print data and transmits the print data to an image forming apparatus 300. The image forming apparatus 300 has a printing function, and is connected to the print data output device 100, for example, by a local area network (LAN) or a wireless local area network (WLAN).

A host computer, including a printer driver recognizable by the image forming apparatus 300, is a suitable example of the print data output device 100, and a printer is a suitable example of the image forming apparatus 300. However, the print data output device 100 is not limited to being a host computer. Similarly, the image forming apparatus 300 is not limited to being a printer.

The print data output device 100 may include a user input section 110, a central processing unit (CPU) 120, a memory 130, an application program section 140, a printer driver section 150 including a pattern image generating section 200, a spooler 160 and an interface section 170. The pattern image generating section 200 and other components of the print data output device 100 to generate or print data corresponding to a pattern image may constitute the pattern image generating apparatus.

The user input section 110 is an interface for a user to select functions supported in the print data output device 100. For example, a key board, a mouse, and a touch panel are non-limiting examples suitable as the user input section 110. The user input section 110 outputs and sends a print request signal to the CPU 120 to request the printing of a document.

The CPU 120 controls an operation of the print data output device 100 using various control programs stored in the memory 130. Once the CPU 120 receives the print request signal from the user input section 110, the CPU executes application programs in the applications program section 140, and operates the printer driver of the printer driver section 150, related to the print request signal.

The memory 130 may include a non-volatile, read only memory (ROM; not illustrated), to store various control programs required for a function of the print data outputting device 100. Furthermore, the memory 130 may include a non-volatile, random access memory (RAM; not illustrated), to store various data generated during operation of the print data outputting device 100.

The application program section 140 includes the application programs through which the user can write various documents to be printed. When one or more of the various documents (e.g., a document-to-be-printed) written through the application program section 140 is printed, the application program section 140 provides the printer driver section 150 with the document-to-be-printed, along with a print order option selected by the user. In addition, when the document-to-be-printed includes an image having a predefined pattern, the application program section 140 provides the printer driver section 150 with a pattern ID corresponding to the predefined pattern. In a Microsoft® Windows® system, for example, suitable predefined patterns include, but are not limited to, a horizontal pattern, a vertical pattern, a diagonal pattern, a cross pattern, and a diagonal cross pattern (which are hatch patterns). Also, suitable application programs include, but are not limited to, a word processor, a data base program, a web browser, a tool, a paintbrush, and an image editing program.

According to the print order option selected by the user, the printer driver section 150 converts the document-to-be-printed into corresponding print data having a data format that can be recognized by the image forming apparatus 300.

Referring to FIG. 4, the pattern image generating section 200 may include a pattern attribute storage section 210 to store a pattern attribute, a pattern generating control section 220 to control generation of the pattern image, and a pattern rendering section 230.

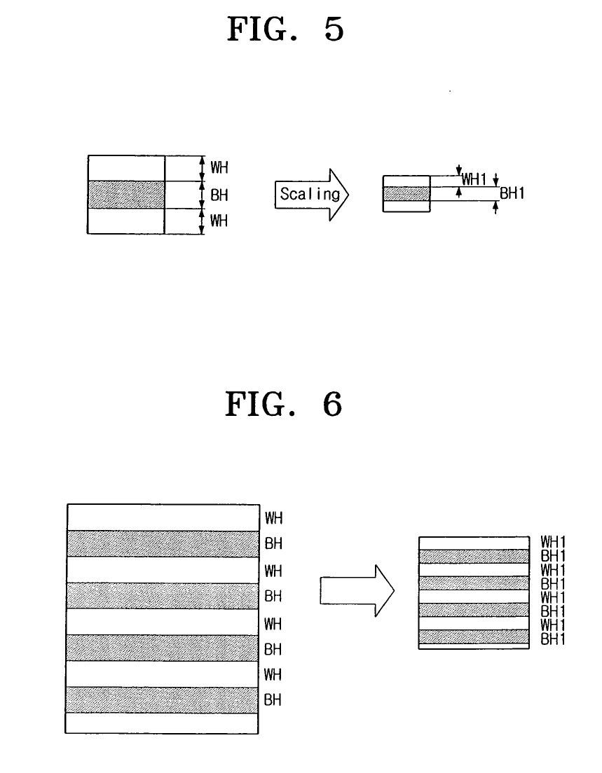

A pattern attribute is data required to render a corresponding pattern image. The pattern attribute may include a magnitude value of each diagram part corresponding to each predefined pattern. For example, FIG. 5 illustrates a pattern, and the pattern includes a diagram part having a basic unit of the pattern or a horizontal pattern, for example, lower and upper white colored-horizontal tetragons, each having a height WH, and a black colored-horizontal tetragon placed between white colored-horizontal tetragons, having a height BH. Using the pattern attribute (e.g., the basic unit having the white colored horizontal line patterns with the heights WH and the black colored horizontal line pattern with the height BH disposed alternatively as illustrated in FIG. 5) corresponding to the pattern ID provided by the application program section 140, a corresponding pattern can be rendered using the magnitude values WH and BH. Therefore, the pattern attribute of the pattern illustrated in FIG. 5 can be defined as the height values WH and BH.

The pattern generating control section 220 retrieves the pattern attribute of the predetermined pattern (corresponding to the pattern ID provided from the application program 140) from the pattern attribute storage section 210. The pattern generating control section 220 may also receive a reduction ratio included in a reduction print order. Similarly, the pattern generating control section 220 may receive an enlargement ratio included in an enlargement print order.

A range of selectable reduction and enlargement ratios (i.e., scaling ratios) in a typical printer driver is 10% to 400%. The pattern generating control section 220 calculates a scaling pattern attribute using a scaling coefficient SL, which is an integral number obtained by multiplying a scaling ratio from the print order option selected by the user and provided from the application program section 140 by 100. The scaling pattern attribute is the pattern attribute corresponding to the predefined pattern after the predefined pattern has been scaled according to the scaling coefficient to form scaled pattern image data. In other words, the scaling pattern attribute is the pattern attribute of the scaled pattern image data.

For example, when a user selects a reduction ratio of 33% in a reduction print order, the pattern generating control section 220 uses a scaling coefficient of 33 (i.e., the reduction ratio 33% multiplied by 100) to calculate the scaling pattern attribute WH1 and BH1 illustrated in FIG. 5. The scaling pattern attribute is then used to reduce the predetermined pattern (i.e., the predetermined pattern on the left side of the arrow in FIG. 5) at a ratio of 33% to generate a reduced pattern (i.e., the scaled pattern on the right side of the arrow in FIG. 5). The calculated scaling pattern attribute may be stored in the pattern attribute storage section 210.

The pattern generating control section 220 then provides the pattern rendering section 230 with the scaling pattern attribute stored in the pattern attribute storage section 210. The pattern rendering section 230 renders the scaled pattern image to the corresponding page area of the print data using the scaling pattern attribute.

Again, referring to FIG. 3, the spooler 160 provides the interface section 170 with the print data output from the printer driver section 150 to transmit the print data to the image forming apparatus 300. For example, the spooler 160 may provide the print data to the interface section 170 in units of pages.

The interface section 170 connects the print data output device 100 and the image forming apparatus 300 to send and receive the print data. That is, the interface section 170 sends the print data of the document-to-be-printed to the image forming apparatus 300, and receives data transmitted from the image forming apparatus 300. The image forming apparatus 300 performs the selected print order using the print data transmitted from the print data output device 100 such that a second image having scaled patterns according to the print order is printed.

When the print data output device 100 includes a hard disk drive, the application program section 140, the printer driver section 150, and the spooler 160 can be installed in the hard disk drive. However, the application program section 140, the printer driver section 150, and the spooler 160 are not required to be included in the hard disk drive, when the hard disk drive is present. For example, when the hard disk drive is present, any or all of the application program section 140, the printer driver section 150, and the spooler 160 may be absent from the hard disk drive. Furthermore, the print data output device 100 does not require the hard disk drive.

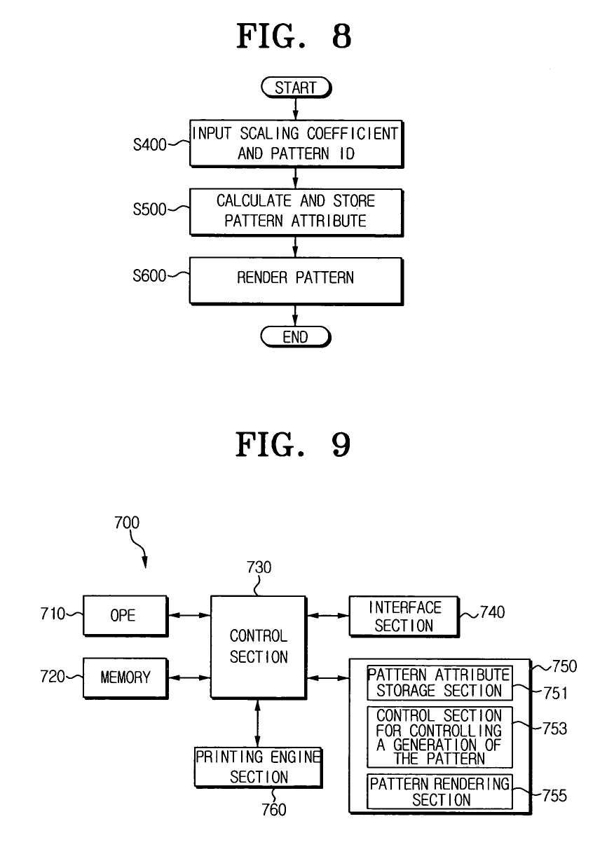

FIG. 8 is a flow chart illustrating a method of generating a pattern image according to an embodiment of the present general inventive concept. The method of generating the pattern image according to this embodiment of the present general inventive concept will be described below with reference to FIG. 3 to FIG. 8.

Once a print order including a scaling print option for a document-to-be-printed in the application program section 140 is input through the user input section 110 by a user, the user input section 110 sends a print request signal to the CPU 120. The CPU 120 controls the application program section 140 to provide the printer driver section 150 with the document-to-be-printed along with the selected scaling print option. When the document-to-be-printed includes an image having a predefined pattern, the application program section 140 provides the printer driver section 150 with a pattern ID corresponding to the predetermined pattern. For example, the print order may include a print option to reduce the document-to-be-printed at a ratio of 50%, and a horizontal pattern in the predefined pattern may be included in the document-to-be-printed.

According to the selected print order, the printer driver section 150 converts the document-to-be-printed into print data having a data format that can be recognized by the image forming apparatus 300. For example, the pattern image generating section 200 may receive the pattern ID of the predetermined pattern and a scaling coefficient calculated using the selected scaling ratio (e.g., the reduction ratio of 50%) (see operation S400 of FIG. 8).

Next, the pattern generating control section 220 retrieves a pattern attribute corresponding to the pattern ID of the predetermined pattern from the pattern attribute storage section 210. The pattern generating control section 220 calculates a scaling pattern attribute using the pattern attribute and the scaling coefficient, and then stores the calculated scaling pattern attribute in the pattern attribute storage section 210 (see operation S500 of FIG. 8)

Referring to FIG. 5, the pattern attribute corresponding to the pattern ID of the predetermined pattern can be expressed as “WH” and “BH”. Accordingly, the pattern generating control section 220 calculates WH1 and BH1, which are the scaling pattern attributes of the scaled patterns using a scaling coefficient SL and WH and BH according to the Equation 1
WH1=(SL×WH)/100
BH1=(SL×BH)/100 (Equation 1).

However, in the case where the values of WH1 and BH1 obtained by the above Equation 1 are not divisible by the integral number scaling coefficient SL, the values of WH1 and BH1 may be converted into the integral numbers through a calculation method, such as by rounding up or down the values of WH1 and BH1. Referring to FIG. 6, the predetermined pattern having the pattern attribute is illustrated at a left side of the arrow, and the scaled pattern that has been reduced at the ratio of 50% from the predetermined pattern is illustrated at a right side of the arrow.

Once the scaling pattern attribute of the scaled pattern is calculated by the pattern generating control section using according to the scaling coefficient, and then stored in the pattern attribute storage section 210, the pattern rendering section 230 renders the scaled pattern image. Specifically, the pattern rendering section 230 renders the scaled pattern image using the stored scaling pattern attribute according to the print order and the predefined pattern (see operation S600 in FIG. 8)

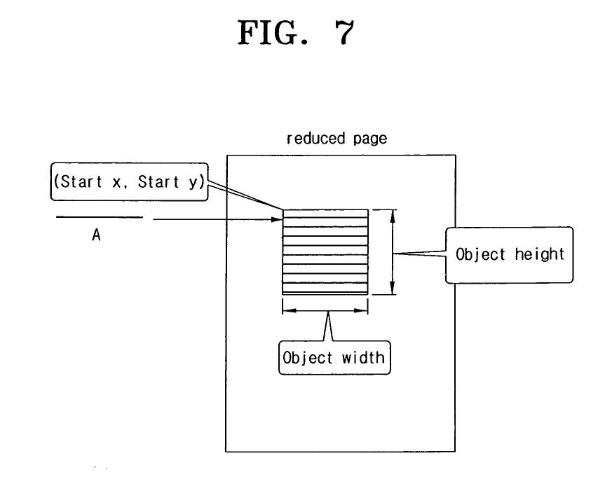

The pattern rendering section 230 receives object information corresponding to the predetermined pattern image to be rendered from the document-to-be-printed provided to the printer driver section 150. Referring to FIG. 7 as an example, the object information may include start coordinates Start x and Start y at which the scaled pattern becomes rendered in the scaled page, and a width and a height of the object to be rendered.

The pattern rendering section 230 sets current location coordinates from the start coordinates according to the object information to render the scaled pattern image. Also, the pattern rendering section 230 corrects the current location coordinates such that the current location coordinates do not exceed the width and the height of the object and performs a pattern image rendering process at the same time.

In more detail, the pattern rendering section 230 may be moved in a vertical direction as much as WH1 calculated by the pattern generating control section 220, and so the vertical location coordinate is increased as much as WH1. Subsequently, the pattern rendering section 230 renders the black colored tetragon (or another required colored tetragon) having the height of BH1 to make the above tetragon have a width that is same as that of the object and to increase the current location coordinates as much as BH1. The rendering process may compare the current location coordinates with the width and the height of the object at various times throughout the rendering process to ensure that the current location coordinates do not exceed the width and the height of the object.

FIG. 9 is a block diagram illustrating an image forming apparatus to which a pattern image generating apparatus according to an embodiment of the present general inventive concept is applied.

An image forming apparatus 700 is provided to print a scaled pattern image. The image forming apparatus may be, for example, a printer to print a print data transmitted from a print data output device.

Referring to FIG. 9, the image forming apparatus 700 may include a motion panel section (OPE) 710, a memory 720, a control section 730, an interface section 740, a pattern image generating section 750 and a printing engine section 760.

The motion panel section 710 may include a plurality of keys to select and set a function supported by the image forming apparatus 700. Furthermore, the motion panel section 710 may include an input section (not illustrated) provided a touch panel and to supply a selected function signal to the control section 730, and a display section (not illustrated) to display an operation status of the image forming apparatus 700. The display section may be, for example, a liquid crystal display (LCD).

The memory 720 may include a non-volatile read only memory (ROM; not illustrated) to store one or more control programs required for performing a function of the image forming apparatus 700, and/or a non-volatile random access memory (RAM; not illustrated) to store various data generated during operation of the image forming apparatus 700.

The control section 730 may control the operation of the image forming apparatus 700 according to the one or more control programs stored in the memory 720. Once print data including a print option is received by the control section 730 through the interface section 740, the control section 730 controls the printing engine section 760 to print the received print data according to the print option.

The interface section 740 may communicate with the printing data output device using, for example, at least one slot, a USB port for using a USB (universal serial bus) communication method, or an interface, such as an IEEE 1394 (Institute of Electrical and Electronic Engineering 1394).

The pattern image generating section 750 according to the present general inventive concept may include a pattern attribute storage section 751, a pattern generating control section 753, and a pattern rendering section 755. The pattern image generating section 750 illustrated in FIG. 9 performs a function similar to that of the pattern image generating section 200 illustrated in FIG. 2, and so the detailed description thereon is omitted.

The pattern image generating section 750 can be mounted to the image forming apparatus 700 as a module. Alternatively, when the image forming apparatus 700 includes a hard disk drive, the pattern image generating section 750 can be located in the hard disk drive.

When the print data including the print option is transmitted from the print data output device, the control section 730 performs the various image processing processes required to output the scaled pattern image from print engine section 760 using the application programs stored in the memory 720.

The control section 730 may provide the pattern image generating section 750 with a pattern ID corresponding to the predetermined pattern. In addition, the control section 730 may provide the pattern image generating section 750 with an enlargement ratio or a reduction ratio (or a scaling coefficient) when a user selects an enlargement or a reduction scaling print as the print option.

Accordingly, the pattern image generating section 750 performs the function which is similar to that of the pattern image generating section 200 illustrated in FIGS. 3 and 4, i.e., calculates and stores a scaling pattern attribute of the scaled pattern image, which is scaled according to the scaling coefficient and the pattern ID. The pattern image generating section 750 renders the pattern image to a corresponding area (that is, an object) of a page according to the stored scaling pattern attribute.

The printing engine section 760 prints the printing data pages onto, for example, paper, under the control of the control section 730.

As described above, according to a method and apparatus to generate a pattern image according to an embodiment of the present general inventive concept, when a scaled pattern image for a document having a predetermined pattern image is printed, printing quality of the predetermined pattern image and of the scaled pattern image can be enhanced and improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of generating a scaled pattern image, the method comprising:
inputting a scaling ratio and a pattern ID of a first unit pattern corresponding to a first pattern image of a document based on print data received in a scaling print order;
reading a stored pattern attribute corresponding to the pattern ID;
calculating and storing a scaling pattern attribute corresponding to a second unit pattern obtained by scaling the first unit pattern according to the scaling ratio; and
rendering a second pattern image corresponding to the second unit pattern using the scaling pattern attribute.

2. The method according to claim 1, wherein the stored pattern attribute comprises magnitude data of at least one portion of the first unit pattern.

3. The method according to claim 2, wherein the calculating and storing of the scaling pattern attribute comprises scaling the magnitude data of the stored pattern attribute using the scaling ratio.

4. The method according to claim 2, wherein the calculating and storing of the scaling pattern attribute comprises:
multiplying the magnitude data of the stored pattern attribute by a scaling coefficient to generate a resulting value; and
calculating the scaling pattern attribute by converting the resulting value into an integral number.

5. The method according to claim 1, wherein the rendering of the second pattern image comprises:
determining a predetermined area on a print medium to which the scaled pattern image is to be rendered from the print data; and
rendering the second pattern image at a specific position on the print medium using the scaling pattern attribute, wherein the specific position is located in the predetermined area.

6. An apparatus to generate a pattern image, the apparatus comprising:
a pattern attribute storage section to store a pattern attribute corresponding to a pattern ID of a predefined pattern;
a pattern generating control section to control a generation of the pattern image by reading the pattern attribute corresponding the pattern ID from the pattern attribute storage section, calculating a scaling pattern attribute of a scaled pattern obtained by scaling the predefined pattern according to a scaling ratio, and storing the calculated the scaling pattern attribute in the pattern attribute storage section; and
a pattern rendering section to render a scaled patterning image having the scaled pattern to a predefined area of a print medium according to the scaling pattern attribute.

7. The apparatus according to claim 6, wherein the pattern attribute comprises magnitude data of at least one portion of the predefined patter.

8. The apparatus according to claim 7, wherein the pattern generating control section scales the magnitude data using the scaling ratio to calculate the scaling pattern attribute.

9. The apparatus according to claim 7, wherein:
the pattern generating control section multiplies the magnitude data by a scaling coefficient to generate a resulting value; and
the pattern generating control section calculates the scaling pattern attribute by converting the resulting value into an integral number.

10. The apparatus according to claim 6, wherein:
the pattern rendering section determining a predetermined area on a print medium to which the scaled pattern image is to be rendered from the print data; and
the pattern rendering section renders the second the pattern image at a specific position on the print medium using the scaling pattern attribute, wherein the specific position is located in the predetermined area.

11. The apparatus according to claim 6, wherein the apparatus is located in one of a printer driver and an image forming apparatus.

12. A system to generate a scaled pattern image, the system comprising:
an image forming apparatus to print the scaled pattern image;
a printing data output device to output scaled pattern image data; and
a pattern image generating unit to drive the generation of the scaled pattern image data, the pattern image generating unit comprising:
a pattern generation control unit to generate a scaled pattern attribute from an input pattern attribute;
a pattern attribute storage unit to store the scaled pattern attribute generated by the pattern generation control unit; and
a pattern rendering unit to render the scaled pattern image data using the scaled pattern attribute.

13. The system of claim 12, wherein the pattern image generating unit is located in the image forming apparatus.

14. A method of generating a scaled pattern image, the method comprising:
generating scaled pattern attribute from an input image pattern attribute;
storing the scaled pattern attribute; and
rendering the scaled pattern image data by scaling the input image pattern attribute using the scaled pattern attribute.

15. The method of claim 14, wherein the generating the scaled pattern attribute comprises:
determining a pattern ID corresponding to the input image;
determining a pattern attribute corresponding to the pattern ID;
calculating a scaling coefficient using a predetermined scaling ratio;
generating the scaled pattern attribute using the scaling coefficient.

16. An apparatus to generate a pattern image, comprising:
a storage unit to store first data corresponding to an image having one or more pattern images and second data corresponding to one or more attributes of the one or more pattern images of the image; and
a control unit to scale the one or more pattern images of the image according to the first data, the second data, and third data corresponding to one or more second attributes of a second image to generate the second image having the scaled pattern images.

17. The apparatus of claim 16, further comprising:
an image forming apparatus having a print engine to print the second image,
wherein the storage unit and the control unit are included in the image forming apparatus.

18. The apparatus of claim 16, further comprising:
a host having the storage unit and the control unit to generate the second image; and
an image forming apparatus to print the second image.

19. The apparatus of claim 16, wherein a ratio between the one or more attributes and the one or more second attributes comprises a reduction and/or enlargement ratio.
